(19) United States
(12) Patent Application Publication
(10) Pub. No.: US 2007/0111727 A1
(43) Pub. Date: May 17, 2007

(54) System and method for enhanced mobility tracking of mobile stations

(76) Inventor: J.C. Stanaway, Wheaton, IL (US)

Correspondence Address: MOTOROLA, INC., 1303 EAST ALGONQUIN ROAD, IL01/3RD, SCHAUMBURG, IL, 60196, US

(21) Appl. No.: 11/280,991

(22) Filed: Nov. 17, 2005

(51) Int. Cl. H04Q 7/20

(52) U.S. Cl. 455/433; 455/458; 455/456.1

(57) ABSTRACT

A location area (102) associated with a mobile station (104) is stored at a first memory location (122). A current cell (108) associated with the mobile station (104) is stored at a second memory location (124). To address race conditions between attempts to page a mobile station and that mobile station needing to update the network with its new location area, both the stored location area and the current cell of the mobile station (104) are simultaneously paged when a request is received to contact the mobile station (104).

### FIELD OF THE INVENTION

The field of the invention relates to tracking mobile stations in networks and, more specifically, to tracking mobile stations in networks so that communications can be correctly routed to these mobile stations.

### BACKGROUND OF THE INVENTION

In telecommunication systems, various Fixed Network Elements (FNEs) can be used to track and store the location of mobile stations. For instance, after the location of a mobile station has been determined to be in its home network, a Home Location Register (HLR) may be used to store the identity of a network in which a mobile station is located and a Visitor Location Register (VLR) may be used to store the location area in which the mobile station is located in the current network. These location areas are also commonly referred to as “paging areas.”

As a mobile station moves between various location areas, it normally updates the system as to which location area it has moved. When the mobile station is the target of a call, the system pages all cells within that location area in order to locate the mobile station for that call.

However, current systems only update the current location area of a mobile station when the mobile station reports that it has moved. If a mobile station changes location areas while in a call, the system does not update the current location area for that mobile station and the mobile station and the system are typically no longer synchronized.

In one specific example of approaches used in current systems, users frequently conduct voice conversations. During these conversations, pauses sometimes occur and the conversations must be extended across multiple calls in order to be completed. For instance, a user might actuate a pause button at a mobile station during a conversation, and if the length of the pause is too long, the call is terminated by the system. In another example, with dispatch communications, if there is no active talker for a predetermined amount of time, the call is terminated by the system. Consequently, a new call or calls must be established to allow the user to continue and complete the conversation.

Problems occur if a call is terminated and the mobile station has moved out of its original location area to a new location area or cell. Specifically, if a mobile station has moved to a different location during the call, then when the call has terminated, the mobile station must update the system with its new location before it can receive a page for subsequent calls. However, if the other party in the call attempts to reestablish the call too quickly (and the mobile station has moved to a new, unknown location area outside its original location area), the system pages the wrong location area since a location update has not been performed.

If a mobile station changes location areas while in a call, current systems do not update the current location area for that mobile station. The update is made only when the mobile station explicitly reports its current location area to the system. If the system were to automatically update the location area of the mobile station when the mobile station changes location areas during a call, then it is possible that when the call is terminated, the mobile station would return to idle in the old location area. Since the mobile station in this scenario never reports a change in location areas to the system during the call, it does not report that it moved back to the old location area when the call terminates and, therefore, the system no longer has the current location area of the mobile station. Therefore, current systems do not automatically update the location area of the mobile station.

As a result of these problems, FNEs in current systems possess stale information concerning the location of the mobile station for some amount of time after a call terminates and, during the call, the mobile station had moved away from its original location area. Because the information is outdated, current systems are unable to correctly locate the mobile station and call attempts to the mobile station often fail. Consequently, the conversation can not be continued or can be continued only after an inconvenient length of time.

Furthermore, in some current systems, if the mobile station does not respond to an initial paging cycle, the system pages adjacent location areas. Such approaches delay call setup as the adjacent location areas are paged only after the initial paging attempt fails, are not efficient as many additional cells are paged, and require additional complexity when configuring the system such that the system has knowledge of which location areas are adjacent to other location areas.

### BRIEF DESCRIPTION OF THE DRAWINGS

FIG. 1 is a block diagram of a system for tracking the movement of a mobile station according to an embodiment of the present invention;

FIG. 2 is a flowchart of one example of an approach for tracking the movement of a mobile station according to an embodiment of the present invention;

FIG. 3 is a block diagram of a processing device used to track a mobile station according to an embodiment of the present invention;

FIG. 4 is a call flow diagram of an approach for tracking a mobile station according to an embodiment of the present invention; and

FIG. 5 is a flow chart of an approach for tracking the movement of a mobile station according to an embodiment of the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. In addition, it should be well understood that different elements may have multiple instances, but are not depicted in order to facilitate a less obstructed view of these various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE PREFERRED EMBODIMENTS

A system and method is provided that accurately tracks the location of a mobile station so that ongoing conversations between users that have been interrupted may be continued. In particular, the location of a mobile station is tracked even if the mobile station moves from its original location area to a new cell or location area. Consequently, if the conversation is interrupted during or shortly after the movement of the mobile station to the new cell or location area, the mobile station can be located, a new call can be established, and the conversation can be continued.

In many of these embodiments, a location area associated with a mobile station is stored at a first memory location. The location area may be a communication cell or a group of cells. A current cell associated with the mobile station is stored at a second memory location. Both the stored location area and the current cell of the mobile station are simultaneously paged when a request is received to contact the mobile station, for example, a request to establish a new call to continue an interrupted or paused conversation. Since the mobile station is at one of these locations, it will receive the page and, consequently, a conversation that has been interrupted may be continued.

In some of these embodiments, the current cell may be identified in an in-call mobility message. Examples of in-call mobility messages include a Service Request message, a handover message, and a Reconnection Request message as used in the Integrated Digital Enhanced Network (iDEN) system manufactured by Motorola, Inc. Other examples of in-call mobility messages are possible. In addition, the second memory location may be cleared whenever the mobile station explicitly updates the network with a current location area. In one example, the clearing may be initiated by Location Update messages, Registration Renewal messages or Dispatch Registration messages (also as used in the iDEN system). Other examples of messages can also be used to clear the second memory location.

In addition, the approaches described herein may be performed or implemented within any type of communication system. For example, the approaches described herein may be implemented in dispatch communication systems, cellular communication systems, or combinations of these systems.

Thus, a system and method are provided that accurately and efficiently tracks the location of a mobile station so that, after a conversation during a call is interrupted, a new call can quickly be established to continue the conversation without the need to go through additional paging cycles in which adjacent location areas are paged. The approaches described herein are easy to implement and result in conversations being automatically continued even after pauses are made during a call, the call is dropped, and a new call needs to be established.

It should be appreciated that with knowledge of the current cell of a mobile station, the system could page only the current cell and if that fails optionally page the old location area and/or page the location area to which the current cell belongs. In the event that the current cell belongs to overlapping location areas, the system may page all of the location areas to which the current cell belongs. Other variations also exist, including, for example, paging all cells of a sectored site when the cell belongs to a sectored site.

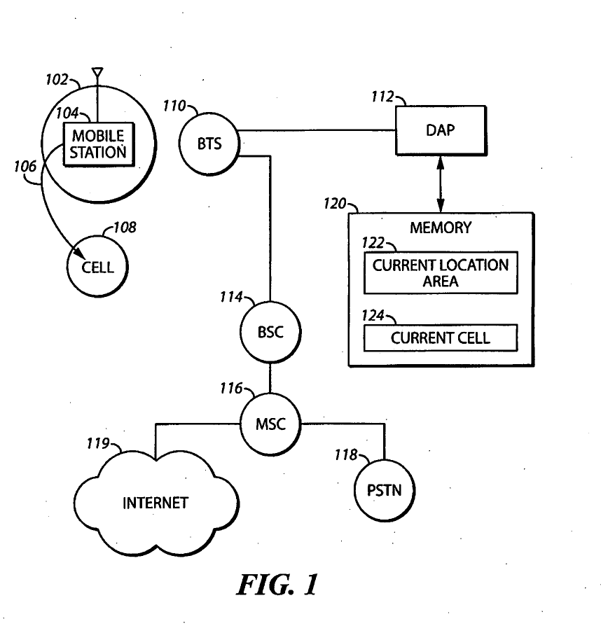

Referring now to FIG. 1, one example of a system for tracking a mobile station so that pages may be made to the correct location of a mobile station is described. The system includes a mobile station 104, which operates within a location area 102. The location area 102 may comprise one or more communication cells (not shown for simplicity in FIG. 1).

The mobile station 104 may be any type of mobile communication device such as a cellular telephone, pager, personal computer, or personal digital assistant (PDA). Other examples of mobile stations are possible. The mobile station 104 may move back-and-forth between the location area 102 and a cell 108 along a path 106. As shown in FIG. 1, the cell 108 is not located within the location area 102, but instead is located immediately next to the area 102. Alternatively, the cell 108 may be positioned at another location, which is a significant distance away from the location area 102. It will be understood that other cells and location areas may also exist in the system illustrated in FIG. 1 and that the mobile station 104 may move between these cells and location areas as well.

The mobile station 104 transmits signals to a Base Transceiver Station (BTS) 110. The BTS 110 may include base stations, receivers, transmitters, and other devices that allow the mobile station 104 to communicate with other elements in the system. The BTS 110 is connected to a Dispatch Applications Processor (DAP) 112 and a Base Site Controller (BSC) 114.

The DAP 112 is responsible for tracking the movement of the mobile station 104 for dispatch and packet data services and performing the call control for these services. Additionally, the DAP 112 is responsible for routing data and controlling the operation of the BTS 110 for dispatch and packet data services. In this regard, the DAP 112 may access two memory locations 122 and 124 in a memory 120. The memory 120 may be any type of memory device and the memory 120 may reside inside or outside of the DAP 112. In addition, the memory locations 122 and 124 may be located at different memory devices. For instance, one of the memory locations may be located at a Visitor Location Register (VLR), the other memory location may be located at another memory register or both may be located in the VLR.

The BSC 114 is responsible for routing data, controlling the operation of the BTS 110 for telephony services and is connected to a Mobile Switching Center (MSC) 116. The MSC 116 is responsible for tracking the movement of the mobile station 104 for telephony services and performing the call control for these services. In this regard, the MSC 116 may access the two memory locations 122 and 124 in a memory 120. The memory 120 may be any type of memory device and the memory 120 may reside inside or outside of the MSC 116. In addition, the memory locations 122 and 124 may be located at different memory devices. For instance, one of the memory locations may be located at a Visitor Location Register (VLR) and the other memory location may be located at another memory register or both may be located in the VLR. The memory locations 122 and 124 may either be shared by the DAP and the MSC or the DAP and the MSC may have their own instances of these memory locations.

The MSC 116 also provides switching and gateway functions that allow data to be transmitted and received from other networks. In this regard, the MSC 116 is connected to a Public Switched Telephone Network (PSTN) 118 and the Internet 119. Users operating various types of equipment (e.g., personal computers and telephones) may, in turn, be connected to the networks 118 and 119.

The following discussion is one example of the operation of the system of FIG. 1 from the perspective of the DAP 112 for dispatch and packet data services, but those skilled in the art should appreciate that this discussion would equally apply to the MSC 116 and BSC 114 for telephony services and any other similar entity which tracks the current location area of a mobile station 104.

In one example of the operation of the system of FIG. 1, the location area 102 (associated with the mobile station 104) is stored at a first memory location 122. A current cell 108 associated with the mobile station 104 is stored at a second memory location 124. Both the stored location area (at memory location 122) and the stored current cell of the mobile station 104 (at memory location 124) are paged when a request is received to contact the mobile station 104.

The current cell 108 may be identified to the DAP 112 in an in-call mobility message. Receipt of the in-call mobility message indicates that the mobile station 104 has changed cells while actively employed in a cell or a service. One example of a triggering event that creates the in-call mobility message is a handover event. Another example of an in-call mobility message is a Reconnection Request message (or a Reconnection Request-like message) as used in an iDEN system manufactured by Motorola, Inc. Other examples of in-call mobility messages are possible. The current cell 108 may also be identified to the DAP 112 in a Service Request message (or a Service Request-like message).

In addition, the second memory location 124 may be cleared whenever the mobile station 104 explicitly updates the network with a current location area. In one example, the clearing may be initiated by receipt of a Registration Renewal or Dispatch Registration message (also as used in the iDEN system). Other types of messages can also be used to initiate the clearing of the second memory location 124.

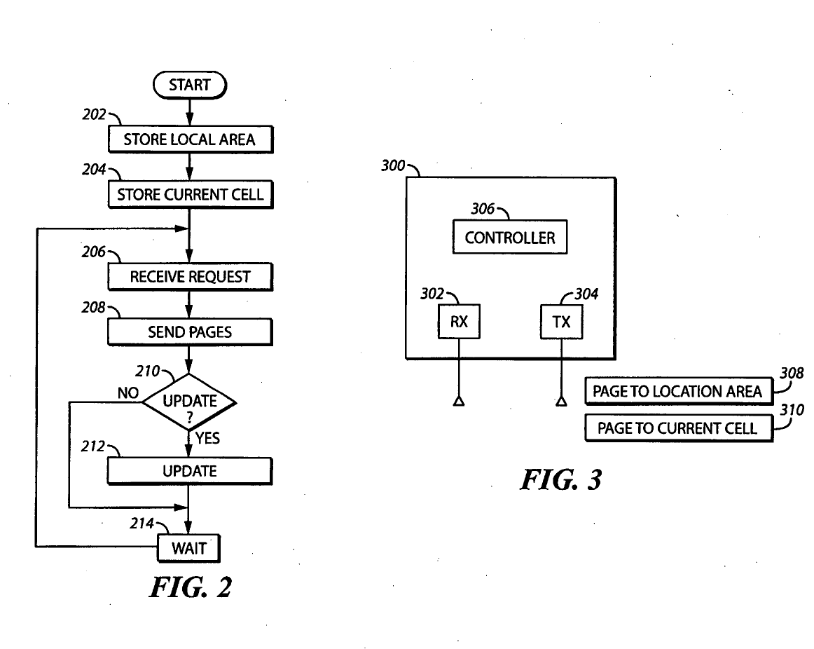

Referring now to FIG. 2, one example of an approach for tracking the location of a mobile station according to the present invention is described. At step 202, a location area associated with a mobile station is stored at a first memory location. At step 204, a current cell associated with the mobile station is stored at a second memory location. This may be accomplished, for example, by receiving an in-call mobility message as described above. At step 206, the system receives a request to communicate with the mobile station. At step 208, the system pages both the location area and the current cell of the mobile station after the request has been received to contact the mobile station.

At step 210, the system determines if an update of the stored current cell has occurred. The updating may occur periodically (i.e., after the expiration of a predetermined time period) or immediately after the system detects that the mobile station has moved to a new cell either inside or outside of the original location area (i.e., upon receipt of another in-call mobility message). If the answer at step 210 is affirmative, at step 212, the current cell is updated. At step 214, the system waits for the next incoming request and then execution continues at step 206 when a request arrives. If the answer at step 210 is negative, then execution continues at step 214 where the system waits for the next request.

Referring now to FIG. 3, one example of a device 300 for tracking a mobile station is described. The processing device 300 includes a receiver 302, a transmitter 304, and a controller 306. In this case, the controller 304 may be programmed to send a page 308 to the stored location area and a page 310 to the current cell of the mobile station via the transmitter 304 whenever a request is received at the receiver 302 to contact the mobile station. The stored location area and current cell may be stored in a memory inside or outside of the device 300.

The device 300 may be implemented as a single device or across multiple devices. For example, the device 300 may be incorporated into a DAP. In this case, the DAP receives the location area and current cell information regarding the mobile station and may store this information in an appropriate memory location or locations for later use and paging.

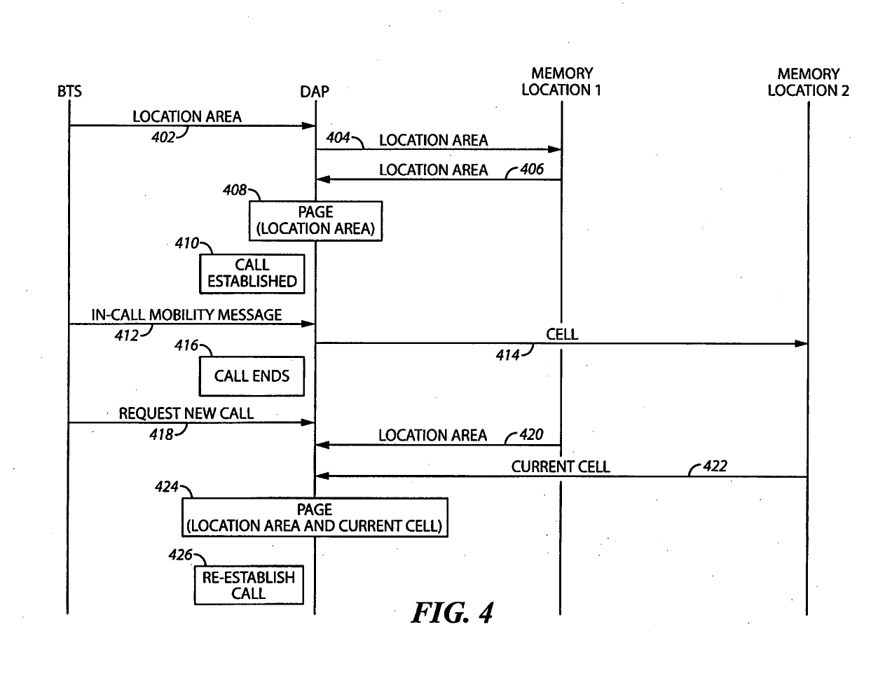

Referring now to FIG. 4, another example of an approach for tracking the location of a mobile station (MS) is described. This example assumes that a mobile station is operating in a system that is the same or similar to the system portrayed in FIG. 1. In this example, while involved in a call, the mobile station moves from its original location area to a new cell outside of the original location area. During, or shortly after the mobile station moves, the on-going call becomes interrupted and, in order to reestablish the call to continue the conversation, a call request is received from the other party involved with the call.

At step 402, sometime prior to the establishment of a call, location area information concerning the mobile station is sent to the DAP from the BTS. This location information identifies the original location area of the mobile station. At step 404, the location information is sent from the DAP to be stored in a first memory location. As previously described, a dispatch registration message, a registration renewal message, or some other type of message which explicitly updates the location area of the mobile station is used to trigger this approach. The DAP also clears the second memory location associated with the current cell of the mobile station.

At step 406, a call is to be established and the (original) location area is retrieved from the first memory location. No current cell information is stored in the second memory location (in this example). At step 408, the mobile station is paged and at step 410, the call is established.

At step 412, an in-call mobility message is sent from the BTS to the DAP and at step 414, a current cell identity is stored in the second memory location. The message includes the current cell of the mobile station. The current cell information included in the message indicates the identity of the cell (either inside or outside of the original location area) where the mobile station is operating. When this message is received, it indicates that the mobile station has changed cells. As indicated above, examples of in-call mobility messages include a handover message (or handover-like message) and a Reconnection Request message (or a Reconnection Request-like message) as used in the iDEN system. If the new cell is within the original location area of the mobile station, the DAP need not store this current cell information.

At step 416, the call ends. At step 418, a request to establish a new call in order to resume the conversation (or from another mobile station to start a new conversation) is received at the DAP from the BTS before the mobile station has had a chance to complete a location updating procedure as described previously. At step 420, the location stored at step 404 (“original location”) is retrieved from the first memory location and at step 422, the current cell is retrieved from the second memory location.

At step 424, both the original location area (including all cells within the original location area) and the current cell are simultaneously paged. Alternatively, rather than paging one additional cell, the system may page several surrounding cells or may page the entire location area which contains the new current cell of the mobile station. At step 426, a new call is established to continue the conversation since the mobile station will be either within the location area or the current cell.

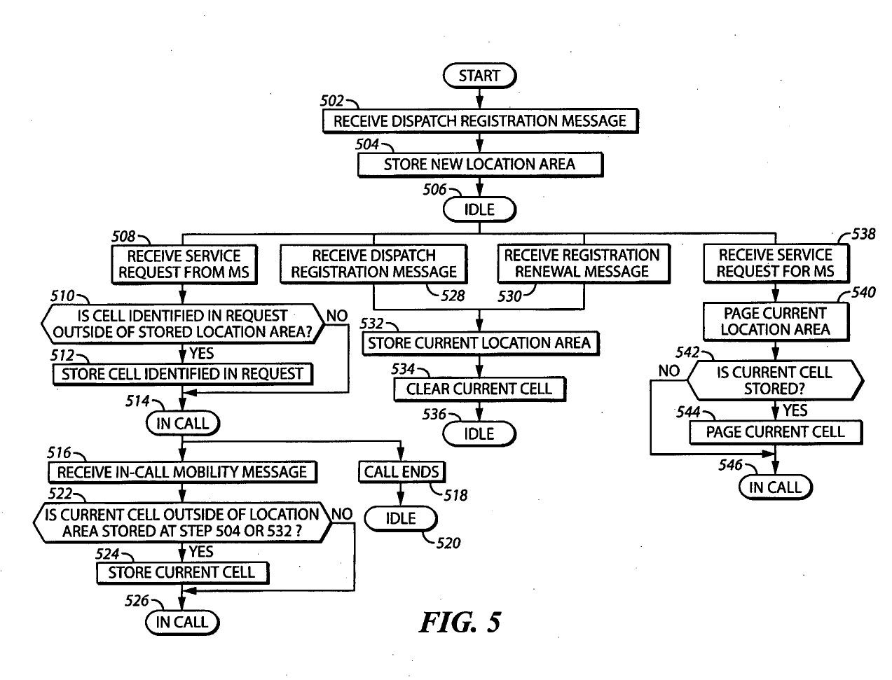

Referring now to FIG. 5, an approach for tracking the movement of a mobile station is described. At step 502, a Dispatch Registration message is received. At step 504, the new location area of the mobile station is stored. At step 506, the system becomes idle.

At step 508, a service request is received from the mobile station. At step 510, it is determined if the cell identified in the request is outside of the stored location area. If the answer is negative, control continues with step 514. If the answer is affirmative, execution continues at step 512.

At step 512, the cell identified in the request is stored. At step 514, the mobile station is engaged in a call. The call may end at step 518 in which case the system becomes idle at step 520. However, if an in-call mobility message is received at step 516, at step 522, it is determined if the current cell is outside of the location area stored at step 504 or step 532. If the answer is negative, then at step 526 the mobile station continues in the call. If the answer is affirmative at step 524, the current cell is stored and at step 526, the mobile station continues in the call.

If the system receives a Dispatch Registration message at step 528 or a Registration Renewal message at step 530, the current location area is stored at step 532. At step 534, the current cell is cleared. At step 536, the system becomes idle.

If a Service Request for the mobile station is received at step 538, at step 540 the current location area of the mobile station is paged. At step 542, it is determined if the current cell has been stored. If the answer is negative, control continues with step 546. If the answer is affirmative, at step 544, the current cell is paged. At step 546, the mobile station is engaged in a call.

Thus, a system and method are provided that accurately track the location of a mobile station so that pages are likely always made to the actual physical location of the mobile station. Consequently, after a conversation has been interrupted, a new call is conveniently established to allow the conversation to continue even though the mobile station has switched location areas and/or cells and has not yet been able to inform the network of its new location.

Those skilled in the art will recognize that a wide variety of modifications, alterations, and combinations can be made with respect to the above described embodiments without departing from the spirit and scope of the invention, and that such modifications, alterations, and combinations are to be viewed as being within the scope of the invention.

What is claimed is:

1. A method of locating a mobile station in a network comprising:
storing a location area associated with a mobile station at a first memory location;
storing a current cell associated with the mobile station at a second memory location; and
paging both the stored location area and the current cell of the mobile station when a request is received to contact the mobile station.

2. The method of claim 1 wherein storing the current cell comprises storing the current cell at the second memory location, the current cell being identified in a message, the message selected from a group comprising: an in-call mobility message and a service request message.

3. The method of claim 1 further comprising clearing the second memory location whenever the mobile station explicitly updates the network with a current location area.

4. The method of claim 3 wherein clearing the second memory location is initiated by receiving a Registration Renewal-like message.

5. The method of claim 3 wherein clearing the second memory location is initiated by receiving a Dispatch Registration-like message.

6. The method of claim 3 wherein clearing the second memory location is initiated by receiving a Location Update-like message.

7. The method of claim 1 wherein storing the current cell comprises storing the current cell where the mobile station is currently operating and wherein the cell where the mobile station is currently operating is located outside of the stored location area.

8. A processing device comprising:
a receiver having an input;
a transmitter having an output;
a memory for storing a location area of a mobile station at a first memory location and a current cell of the mobile station at a second memory location; and
a controller coupled to the memory, the receiver, and the transmitter, the controller being programmed to page both the stored location area and the current cell of the mobile station via the transmitter when a request is received to contact the mobile station.

9. The device of claim 8 wherein the controller is further programmed to responsively clear the second memory location whenever the mobile station explicitly updates the network with a current location area.

10. The device of claim 8 wherein the device operates in a dispatch communication system.

11. The device of claim 8 wherein the device operates in a cellular communication system.

12. A method of locating a mobile station in a network comprising:
detecting that a mobile station is operating in a location area;
identifying the location area associated with the mobile station and storing the location area at a first memory location;
detecting that the mobile station has moved to a cell outside the location area;
storing the cell at a second memory location; and
paging both the location area and the cell of the mobile station when a request is received to contact the mobile station.

13. The method of claim 12 wherein storing the cell comprises storing the cell at the second memory location, the cell being identified in an in-call mobility message.

14. The method of claim 12 further comprising clearing the second memory location whenever the mobile station explicitly updates the network with a current location area.
